(19) United States
(12) Patent Application Publication
(10) Pub. No.: US 2006/0220794 A1
(43) Pub. Date: Oct. 5, 2006

(54) Phase modulation for backscatter transponders

(76) Inventor: Jeffrey Zhu, Richmond Hill (CA)

Correspondence Address: HANLEY, FLIGHT & ZIMMERMAN, LLC, 20 N. WACKER DRIVE, SUITE 4220, CHICAGO, IL, 60606, US

(21) Appl. No.: 11/098,257

(22) Filed: Apr. 4, 2005

(51) Int. Cl. H04Q 5/22

(52) U.S. Cl. 340/10.4; 340/825.58

(57) ABSTRACT

A radio frequency identification system having a passive backscatter transponder employing phase modulation. The transponder selectively couples its antenna to one of two or more impedances, wherein the impedances each produce a reflected signal when coupled to the antenna in the presence of a continuous RF wave from the reader. The reflected signals produced by the impedances are out-of-phase with each other. The transponder switches between impedances to encode transponder information into a reflected signal through phase shifts in the reflected signal. The reader detects the phase shifts in the reflected signal received at the reader to obtain the transponder information. The impedances are selected so as to produce reflected signals having a desired phase relationship or difference and having sufficient amplitude.

### FIELD OF THE INVENTION

The present invention relates to radio frequency identification (RFID) systems, such as electronic toll collection (ETC) systems, and, in particular, to an improved backscatter transponder employing phase modulation in an RFID system.

### BACKGROUND OF THE INVENTION

Radio frequency transponders and RFID tags are used in a variety of communications systems, especially systems in which a plurality of deployed devices, like vehicles, are outfitted with transponders that communicate with a set of readers connected to a central system. These types of distributed mobile communication systems may be employed for electronic toll collection, parking enforcement, valet services, fueling stations, traffic management, and a variety of other purposes.

The transponders used in RFID systems are typically one of two types: active or passive. Active transponders include a power source that supplies electrical energy to the electronics of the transponder, thereby enabling the transponder to generate response signals for broadcast to readers. Passive transponders do not have their own power source. Passive transponders typically employ backscatter techniques for modulating a continuous wave RF transmission from a reader. Backscatter modulation involves electrically switching the transponder's antenna from a reflective to an absorptive characteristic according to the transponder's modulating signal. Existing passive transponders switch the transponder antenna between a load (typically 50 Ohms) and ground. The passive- transponder antenna produces a small reflected signal in which information is encoded based on on-off keying (OOK). The reflected signal is small relative to the continuous wave transmitted by the reader, so it will be appreciated that this OOK amplitude variation may be relatively difficult to detect at the reader.

Existing passive transponders are difficult to design appropriately since they require very efficient antennas to maximize the signal received and the signal returned. This necessarily puts pressure on manufacturers to increase the antenna size, even through it would be desirable to produce a transponder with as small an antenna as possible so as to minimize the size and cost of the transponder. The range of a passive transponder is also limited by the efficiency of its antenna, the power of the reader signal, and the relative amplitude change that the transponder is capable of introducing using backscatter modulation.

Accordingly, it would be advantageous to provide for a transponder that addresses, in part, these or other shortcomings of existing devices.

### SUMMARY OF THE INVENTION

The present invention provides a radio frequency identification system having a passive backscatter transponder employing phase modulation. The transponder selectively couples its antenna to one of two or more impedances, wherein the impedances each produce a reflected signal when coupled to the antenna in the presence of a continuous RF wave from the reader. The reflected signals produced by the impedances are out-of-phase with each other. The transponder switches between impedances to encode transponder information into. phase shifts in a reflected signal. The reader detects the relative phase shifts in the reflected signal received at the reader to obtain the transponder information. The impedances are selected so as to produce reflected signals having a desired phase relationship or difference and having sufficient amplitude. The reader includes a phase detection module for detecting relative phase shifts in the reflected signal.

In at least one embodiment, the present invention provides a transponder having at least four impedances to which the antenna may selectively be coupled so as to allow for quadrature phase shift modulation.

In one aspect, the present invention provides a radio frequency (RF) identification system including a transponder and a reader. The transponder includes an antenna for receiving a continuous wave RF signal and converting it into a received signal, and a first impedance, a second impedance, a controller, and a switch. The switch operates under control of the controller, the switch is coupled to the antenna and selectively connects the antenna to the first impedance or the second impedance. The received signal is returned to the antenna as a reflected signal. The reflected signal includes a first portion corresponding to a reflection from the first impedance and a second portion corresponding to a reflection from the second impedance. The first portion is out-of-phase with the second portion by a phase difference. The reader includes a reader antenna for propagating the continuous wave RF signal and receiving the reflected signal, and a phase detection module for detecting relative phase shifts within the reflected signal.

In another aspect, the present invention provides a radio frequency (RF) identification system that includes a transponder and a reader. The transponder includes an antenna for receiving a continuous wave RF signal and converting it into a received signal, and for propagating a reflected signal. The transponder also includes reflection means for receiving the received signal and reflecting the received signal back to the antenna as the reflected signal, wherein the reflection means includes phase modulation means for encoding the reflected signal with transponder information by creating phase shifts within the reflected signal. The reader includes a reader antenna for propagating the continuous wave RF signal and receiving the. reflected signal, and phase detection means for detecting the phase shifts within the reflected signal and extracting the transponder information.

In another aspect, the present invention provides a reader for use in a radio frequency (RF) identification system employing phase modulation, the system having a transponder, wherein the transponder produces a reflected signal in response to a continuous wave RF signal, and wherein the reflected signal includes transponder information encoded using phase. shifts within the reflected signal. The reader includes a reader antenna for propagating the continuous wave RF signal and receiving the reflected signal, and a phase detection module for detecting relative phase shifts within the reflected signal and extracting the transponder information.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 diagrammatically shows a passive transponder employing backscatter amplitude modulation;

FIG. 2 shows a constellation diagram of the relative phase and relative magnitude of the reflected signals from the passive transponder of FIG. 1;

FIG. 3 shows a graph of a reflected signal received at a reader from the transponder in FIG. 1;

FIG. 4 shows a block diagram of an embodiment of a transponder using backscatter phase modulation;

FIG. 5 shows a constellation diagram of the relative phase and magnitude of the reflected signals from the passive transponder of FIG. 4;

FIG. 6 shows a graph of a reflected signal received at a reader from the transponder of FIG. 4;

FIG. 7 shows a block diagram of another embodiment of the transponder;

FIG. 8 shows a constellation diagram of the relative phase and magnitude of the reflected signals from the passive transponder of FIG. 7;

FIG. 9 shows a graph of a reflected signal received at a reader from the transponder of FIG. 7; and

FIG. 10 shows a block diagram of a system for backscatter RF communications, including the transponder and a reader.

Similar reference numerals are used in different figures to denote similar components.

### DESCRIPTION OF SPECIFIC EMBODIMENTS

Reference is first made to FIG. 1, which diagrammatically shows a passive transponder 10 employing backscatter amplitude modulation. The passive transponder 10 includes an antenna 12, a switch 14, a controller 16, a memory 18, and a load impedance 20.

The switch 14 connects the antenna 12 either to ground or to the load impedance 20. The load impedance. 20 is connected between a terminal of the switch 14 and ground.

The switch 14 operates under control of the controller 16. The controller 16 receives a data signal 22 from the memory 18. The controller 16 operates the switch 14 in accordance with the data signal 22. The data signal 22 may, for example, include transponder information stored in the memory 18. The transponder information will depend on the application of the transponder 10. For example, in an ETC system the transponder information may include the transponder ID number, the last transaction time, the vehicle type, or other such information.

The antenna 12 receives a continuous wave (CW) RF transmission from a distant reader. The reader may send a polling or trigger signal to wake-up the transponder 10 prior to broadcast of the CW transmission. The CW RF transmission induces an RF current (i.e. RF signal) in the antenna 12.

The switch 14 couples the RF signal either to ground or to the load impedance 20. Ground corresponds. approximately to an total reflective characteristic. The load impedance 20 is typically selected to provide an approximately total absorptive characteristic. Accordingly, when the RF signal from the antenna 12 is coupled directly to ground by the switch 12 the reflected signal is maximized, and when the RF signal from the antenna 12 is coupled to the load impedance 20 the reflected signal is minimized. It will be appreciated that the extent to which the RF signal is absorbed by the load impedance 20 will depend on the selection of the load impedance 20 since it will depend on the quality of the match.

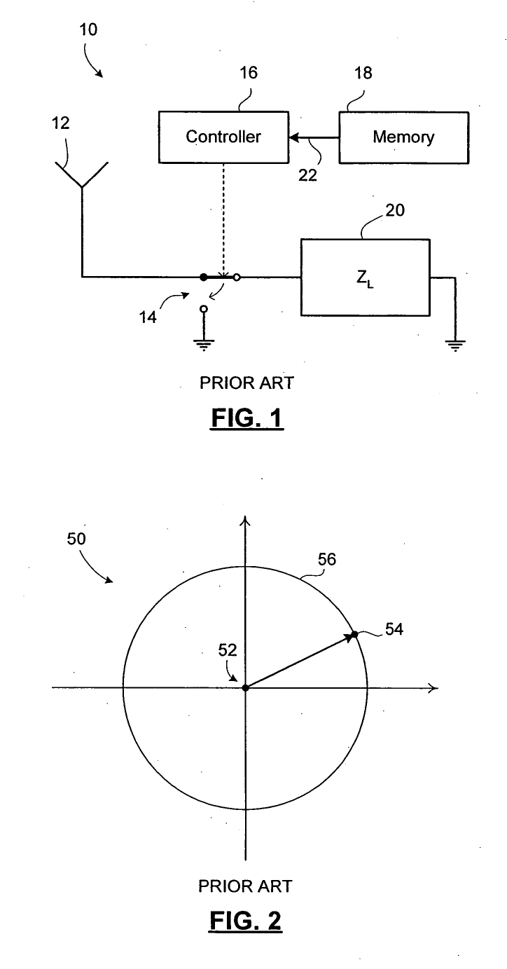

Reference is now also made to FIG. 2, which shows a constellation diagram 50 of the relative phase and magnitude of the reflected signals from the passive transponder 10 of FIG. 1. The point at the origin 52 corresponds to a “total absorption”, i.e. to the reflected signal when the switch 14 couples the antenna 12 to the load impedance 20. The point 54 on the circle 56 corresponds to a “total reflection”, i.e. to the reflected signal when the switch 14 couples the antenna 12 to ground. The magnitude of the relative amplitude difference is given by the radius of the circle 56.

Communication from the transponder 10 to the reader is. facilitated by having the reader identify. relative changes in reflected signal amplitude. The larger the relative magnitude change, the more easily the reader will be able to recognize the changes in antenna loading at the transponder 10 and, accordingly, recover the data signal 22. The precise location of the point 54 on the circle 56 is not relevant to the communication scheme, i.e. the. phase is not taken into account, since the information is encoded by way of amplitude modulation. At the reader, the phase of the reflected signal relative to the phase of the continuous wave signal will depend on the characteristics of the load and the signal path characteristics, i.e. the distance from the transponder to the reader. The RF signal received by the reader will include the reflected signal superimposed upon reflections of the continuous wave signal. Relative phase differences between the reflected signal and reflections of the continuous wave signal can impact the ability of the reader to detect the amplitude variations in the reflected signal. Accordingly, the reader is typically designed to apply appropriate mixing with a signal from a local oscillator in an. attempt to isolate the reflected signal.

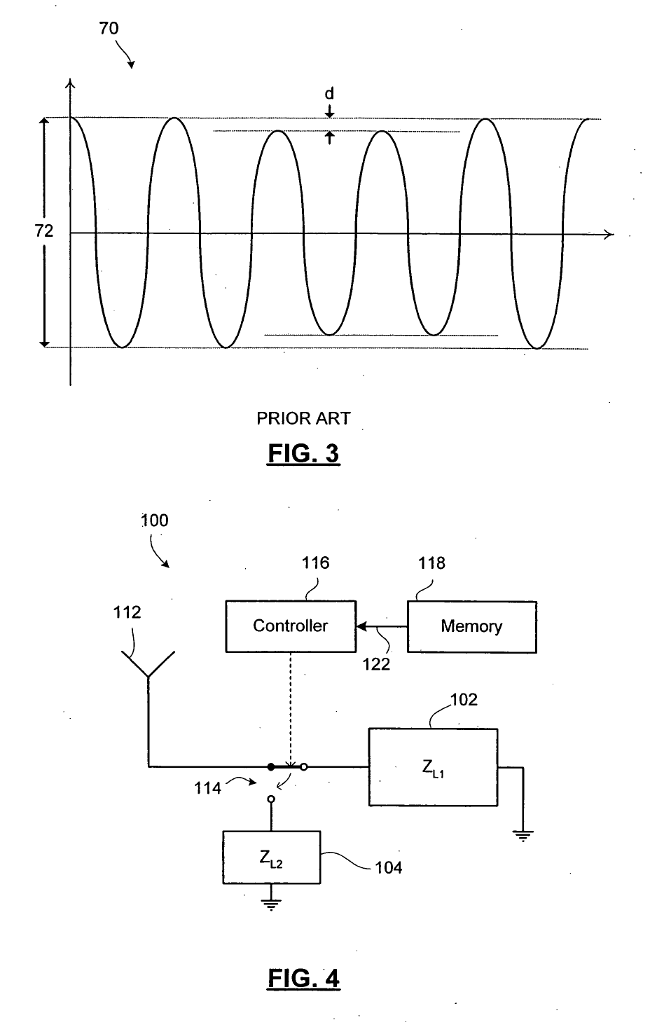

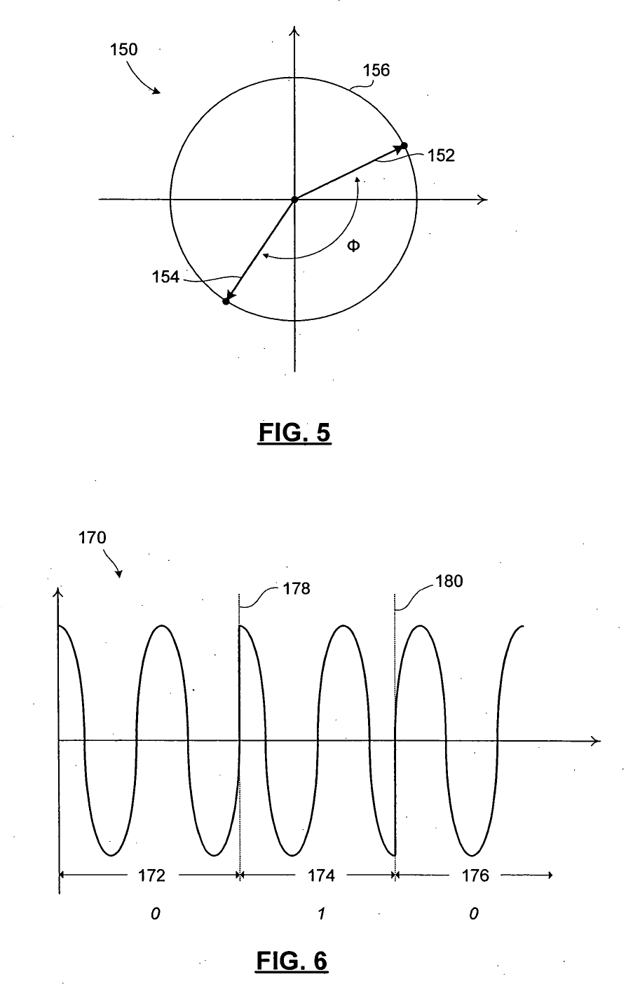

FIG. 3 shows a graph 70 of the signal sensed by a reader from the transponder 10 in FIG. 1. The majority of the sensed signal is due to the continuous wave transmission; however, the reflected signal from the transponder 10 has an impact on the amplitude of the sensed signal. When the antenna 12 is grounded, i.e. providing a total reflective characteristic, the. reflected signal has a maximum amplitude, resulting in a maximum sensed signal peak-to-peak amplitude 72. When the antenna 12 is coupled to the load impedance 20, i.e. a total absorptive characteristic, the sensed signal experiences an amplitude drop of magnitude d. In some embodiments, the magnitude d of the amplitude drop relative to the peak-to-peak sensed signal amplitude may be −60 dB. It will be appreciated that this may be difficult to detect at the reader.

Accordingly, the present invention proposes a transponder for use in an RFID system that uses backscatter phase modulation. Reference is now made to FIG. 4, which shows a block diagram of an embodiment of a transponder 100 using backscatter phase modulation. The transponder 100 includes an antenna 112, a switch 114, a controller 116, and a memory 118. The transponder 100 also includes a first load impedance 102 and a second load impedance 104. The switch 114 couples the antenna 112 to either the first load impedance 102 or the second load impedance 104.

The first load impedance 102 and the second load impedance 104 are selected so as to have a certain absorptive/reflective characteristic. In particular, the two loads 102, 104 are selected such that they produce reflected signals having a relative phase difference. For example, the first load impedance 102 may result in a reflected signal about 180 degrees out-of-phase with the reflected signal produced by the second load impedance 104. It will be understood that the phase difference need not be about 180 degrees, but should be large enough to produce a relative phase change that will be detectable by a receiver of the reflected signal. In one embodiment, the phase difference between the two signals is between 45 degrees and 180 degrees.

Reference is now made to FIG. 4 in conjunction with FIG. 5, which shows a constellation diagram 150 of the relative phase and magnitude of the reflected signals from the passive transponder 100 of FIG. 4. When the antenna 112 is coupled to the first load impedance 102, the reflected signal has a magnitude and phase represented by the first phasor 152. When the antenna 112 is coupled to the second load impedance 104, the reflected signal has a magnitude and phase represented by the second phasor 154. It will be noted that in this example embodiment the magnitudes of the first and second phasors 152 and 154 are approximately the same, i.e. they are both on the circle 156; however, it will be appreciated that this is not necessary in all embodiments. The relative phase difference between the first phasor 152 and the second phasor 154 is shown as angle φ. It will be appreciated that the precise angle φ will depend on the phase difference in the reflected signals produced by the two different impedances 102, 104. It need not be 180 degrees; it may be any value provided it is sufficiently large to be detected by the reader.

Reference is now made to FIG. 6, which shows a graph 170 of a reflected signal from the transponder 100 of FIG. 4. The graph 170 presumes a phase angle φ of approximately 90 degrees. The reflected signal is shown oscillating at a consistent frequency over a first duration 172, a second duration 174, and a third duration 176. A phase change occurs at a point 178 between the first duration 172 and the second duration 174. A second phase change occurs at a point 180 between the second duration 174 and the third duration 176. The first duration 172 may, for example,. represent logic zero and the phase change at point 178 may reflect a change to logic one. The phase change at point 180 may reflect a change back to logic zero. By detecting the relative phase changes in the reflected signal, the reader may extract the information encoded in the reflected signal by the transponder. The reader includes a demodulator that incorporates a phase detection module for detecting relative phase changes in the received reflected signal. The design and implementation of an appropriate phase detection module to detect phase changes in the reflected signal for a given reader-transponder RF system will be within the understanding of one of ordinary skill in the art having regard to the description herein.

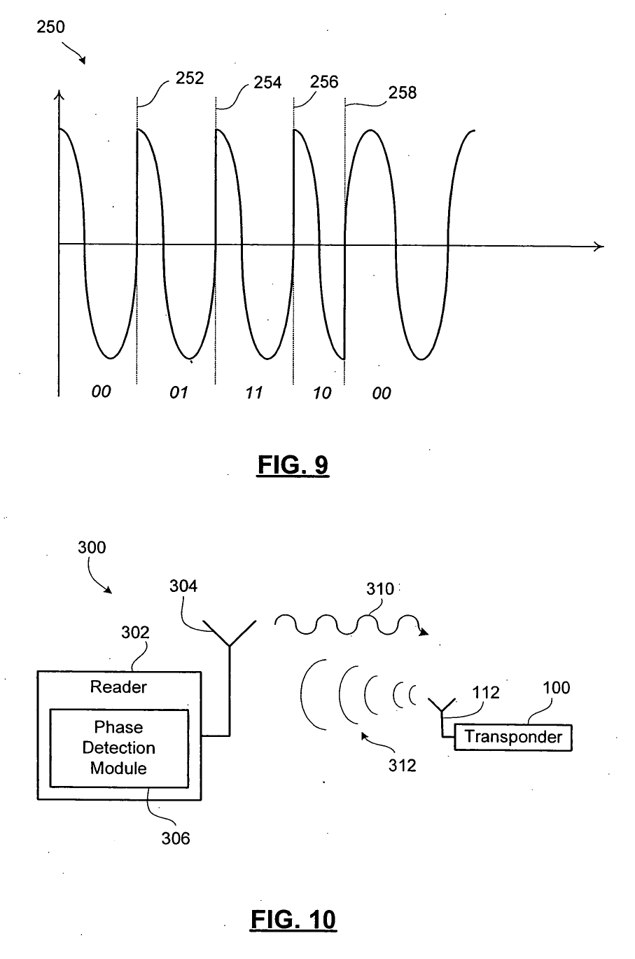

Reference is made to FIG. 10, which shows a block diagram of a system 300 for backscatter RF communications, including the transponder 100 and a reader 302. The reader 302 includes an antenna 304 and it propagates a continuous wave RF signal 310 to energize and/or trigger a response from any transponders in the vicinity of the reader 302. The transponder 100 receives and reflects the continuous wave RF signal 310 as a reflected backscatter signal 312. The reflected. backscatter signal 312 includes phase shifts that encode information stored in memory on the transponder 100. The phase shifts are produced by switching the transponder antenna 112 between two or more impedances selected so as to produce reflected signals having distinctive phase characteristics.

The reader 302 receives the reflected backscatter signal 312 via its antenna 304. The reader.302 includes a phase detection module 306 for detecting the relative phase changes within the reflected backscatter signal 312. The reader 302 thereby receives the information communicated by the transponder via phase modulation. Those of ordinary skill in the art will appreciate that the reader 302 may include other components for isolating and detecting the reflected backscatter signal 312. Once the signal is sufficiently isolated and detected, the phase detection module 306 identifies phase shifts within the signal. The detected phase shifts provide the reader 302 with the information encoded by the transponder 300.

Referring still to FIGS. 4 to 6, it will be. appreciated by those of ordinary skill in the art that the reflected energy in the backscatter field may be modeled by the Hansen vector equation:

$${E}_{s} ( {Z}_{L} ) = {E}_{s} ( 0 ) - [ \frac{I ( 0 ) ( 1 - {Γ}_{A} )}{2} ] {E}_{r} \qquad ( 1 )$$

where Eₛ(0) is the full reflected signal energy corresponding to the antenna 112 being grounded, and Eₛ(Z_{L}) is the backscatter field when the antenna 112 is coupled to an impedance Z_{L}. The second term of Equation 1 represents the energy absorbed by the impedance Z_{L}. In the second term, the vector I(0) represents the current when grounded, the factor ┌_{A} is a reflector coefficient that is determined by the quality of the impedance match, and the vector Eᵣ represents the reflected energy of the signal. By manipulating the impedance Z_{L}, the second term of Equation 1 can be altered to produce a backscatter field energy vector Eₛ(Z_{L}) having a particular phase. Accordingly, through selection of an appropriate Z_{L1} and Z_{L2} the transponder 100 may be made to produce backscatter field energy vectors Eₛ(Z_{L1}) and Eₛ(Z_{L2}) that have a particular phase relationship, such that a reader could receive the field energy and detect phase changes as the transponder 100 switches between the two impedances.

The following non-directional equation is similar to Equation 1 and it models the effective radar cross sectional area when the antenna 112 is coupled to a given impedance:
σ=|\sqrt{σₛ}−(1−Γ_{A})\sqrt{σᵣe^{jφ}}|² (2)
where σₛ represents the radar cross sectional area in the case of a grounded antenna, σᵣ represents the radar cross sectional area corresponding to a reflected signal for a particular impedance, and φ is the relative phase between the two components.

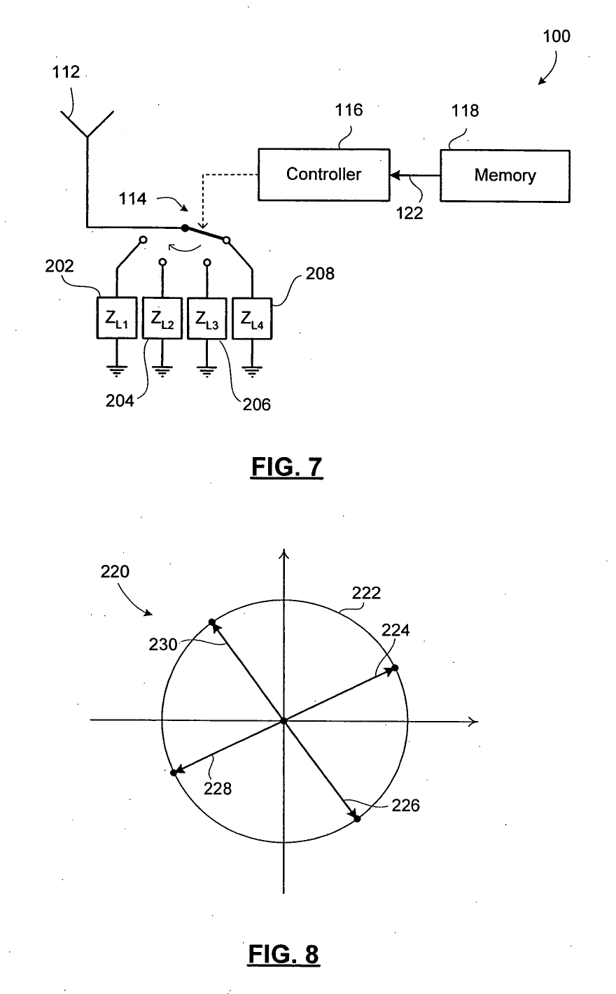

Reference is now made to FIG. 7, which shows a block diagram of another embodiment of the transponder 100. In this embodiment, there are four impedances 202, 204, 206, 208 to which the antenna 112 may be coupled by the switch 114. Each impedance 202, 204, 206, 208 reflects a portion of the incoming RF signal when it is coupled to the antenna, causing the antenna 112 to propagate a reflected signal. The reflected signal corresponding to each impedance 202, 204, 206, 208 differs in phase from the reflected signals corresponding to the other impedances 202, 204, 206, 208. In one embodiment, the impedances 202, 204, 206, 208 are selected such that the reflected signals are spaced approximately 45 degrees apart in phase, allowing for the transponder 100 to engage in quadrature phase shift communications.

Reference is now made to FIG. 8, which shows a constellation diagram 220 of the relative phase and magnitude of the reflected signals from the passive transponder 100 of FIG. 7. The reflected signals corresponding to the four impedances 202, 204, 206, 208 are represented by the four phasors 224, 226, 228, 230.

It will be appreciated that, although the constellation diagrams of FIGS. 5 and 8 show phasors representing reflected signals having the same magnitude, the reflected signals need not necessarily have the same magnitude provided they have a measurable phase difference to enable phase modulation. In some embodiments, data may be communicated by the transponder 100 to the reader using a combination of phase modulation and amplitude modulation.

Reference is now made to FIG. 9, which shows a graph 250 of a reflected signal from the transponder 100 of FIG. 7. The graph 250 presumes a phase angle φ of approximately 90 degrees between successive. reflected signals produced by the series of impedances 202, 204, 206, 208. The reflected signal shown in the graph 250 features 90 degree phase shifts at four points 252, 254, 256, 258. In a differential phase modulation scheme, these phase shifts may reflect a change in the logic pair represented by the reflected signal, as shown below the graph 250.

Those of ordinary skill in the art will appreciate that references in the foregoing description to the phase detection module may be embodied using a variety of discrete or integrated electronic components such as, for example, a microprocessor or microcontroller operating under stored program control and/or an application-specific integrated chip. Other embodiments will be clear to those of ordinary skill in the art. The suitable programming of a microprocessor or microcontroller in accordance with the description herein will be within the skill of a person of ordinary skill in the art.

Those of ordinary skill in the art will also appreciate the wide range of electronic components or devices that may be employed to act as a switch for selectively coupling an antenna to an impedance under the control of a controller, as described above. The switch may, in some embodiments, include a transistor or other solid-state device.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A radio frequency (RF) identification system, comprising:
a transponder, including
an antenna for receiving a continuous wave RF signal and converting it into a received signal;
a first impedance;
a second impedance;
a controller; and
a switch operating under control of the controller, said switch being coupled to said antenna and selectively connecting said antenna to said first impedance or said second impedance,
wherein said received signal is returned to said antenna as a reflected signal and wherein said reflected signal includes a first portion corresponding to a reflection from said first impedance and a second portion corresponding to a reflection from said second impedance, and wherein said first portion is out-of-phase with said second portion by a phase difference;
a reader, including a reader antenna for propagating said continuous wave RF signal and receiving said reflected signal, and a phase detection module for detecting relative phase shifts within said reflected signal.

2. The system claimed in claim 1, wherein said transponder includes a memory containing transponder information and said controller operates said switch based upon said transponder information, and wherein said phase detection module extracts said transponder information from said relative phase shifts.

3. The system claimed in claim 1, wherein said phase difference is determined by the characteristics of said first impedance and said second impedance, said first impedance and said second impedance being selected so as to produce a desired phase difference detectable by said phase detection module.

4. The system claimed in claim 1, wherein said first reflected signal and said second reflected signal have sufficient amplitude to propagate as RF signals to said reader.

5. The system claimed in claim 1, further including a third impedance and a fourth impedance, and wherein said switch may selectively couple said antenna to said first impedance, said second impedance, said third impedance or said fourth impedance, thereby producing said first portion, said second portion, a third portion, or a fourth portion, respectively, of said reflected signal, and wherein each of said portions has a relative phase difference from the other said portions.

6. The system claimed in claim 5, wherein said relative phase difference between each successive portion of said reflected signal in the series of portions is about ninety degrees, thereby enabling said transponder to encode information using quadrature modulation.

7. The system claimed in claim 1, wherein said RF identification system comprises an electronic vehicle toll collection system, wherein said reader comprises a roadside reader and said transponder comprises a vehicle-mounted transponder.

8. The system claimed in claim 1, wherein said reader further includes a receive detector coupled to said reader antenna for receiving incoming signals, isolating said reflected signal, and inputting said isolated reflected signal to said phase detection module.

9. A radio frequency (RF) identification system, comprising:
a transponder, including
an antenna for receiving a continuous wave RF signal and converting it into a received signal, and for propagating a reflected signal;
reflection means for receiving said received signal and reflecting said received signal back to said antenna as said reflected signal, wherein said reflection means includes phase modulation means for encoding said reflected signal with transponder information by creating phase shifts within said reflected signal; and
a reader, including a reader antenna for propagating said continuous wave RF signal and receiving said reflected signal, and phase detection means for detecting said phase shifts within said reflected signal and extracting said transponder information.

10. The system claimed in claim 9, wherein said reflection means includes memory means for storing said transponder information and control means for controlling said phase modulation means in accordance with said transponder information.

11. The system claimed in claim 9, wherein said phase modulation means includes at least two impedance means and a switch means for coupling said antenna to one of said at least two impedance means to generate said reflected signal, and whereby said phase shifts are created by operating said switch means to couple said antenna to another one of said at least two impedance means.

12. The system claimed in claim 11, wherein said at least two impedance means produce a first reflected portion and a second reflected portion, respectively, and said first reflected portion is out of phase with said second reflected portion thereby resulting in said phase shifts within said reflected signal.

13. The system claimed in claim 12, wherein said at least two impedance means are selected such that said phase shifts are detectable by said phase detection means in said reader.

14. The system claimed in claim 11, wherein said at least two impedance means includes four impedance means, and wherein said phase modulation means comprises a quadrature phase shift modulation means.

15. The system claimed in claim 9, wherein said RF identification system comprises an electronic vehicle toll collection system, wherein said reader comprises a roadside reader and said transponder comprises a vehicle-mounted transponder.

16. The system claimed in claim 9, wherein said reader further includes a signal receive means coupled to said reader antenna for receiving said reflected signal, isolating said reflected signal, and inputting said isolated reflected signal to said phase detection module.

17. A reader for use in a radio frequency (RF) identification system employing phase modulation, the system having a transponder, wherein the transponder produces a reflected signal in response to a continuous wave RF signal, and wherein the reflected signal includes transponder information encoded using phase shifts within the reflected signal, the reader comprising:
a reader antenna for propagating the continuous wave RF signal and receiving the reflected signal; and
a phase detection module for detecting relative phase shifts within said reflected signal and extracting said transponder information.

18. The reader claimed in claim 17, wherein the RF identification system comprises an electronic vehicle toll collection system, wherein said reader comprises a roadside reader and said transponder comprises a vehicle-mounted transponder.

19. The reader claimed in claim 17, wherein said reader further includes a receive detector coupled to said reader antenna for receiving incoming signals, isolating said reflected signal, and inputting said isolated reflected signal to said phase detection module.
